(19) United States
(12) Patent Application Publication
(10) Pub. No.: US 2026/0166822 A1
(43) Pub. Date: Jun. 18, 2026

(54) PLASTIC WELDER

(71) Applicant: Drader Manufacturing Industries Ltd., Edmonton (CA)

(72) Inventors: Mai KAAVER, Edmonton (CA); Kevin MCTAVISH, Edmonton (CA); Steven KOSKI, Edmonton (CA)

(21) Appl. No.: 19/119,931

(22) PCT Filed: Oct. 10, 2023
(86) PCT No.: PCT/CA2023/051336

§ 371 Date: Apr. 10, 2025

Related U.S. Application Data
(60) Provisional application No. 63/414,817, filed on Oct. 10, 2022.

(51) Int. Cl. B29C 65/00

(52) U.S. Cl. CPC B29C 66/861; B29C 66/836; B29C 66/9161

(57) ABSTRACT

A plastic welder has a rod passage that extends between a rod insert that receives a plastic rod. One or more engagement wheels frictionally engage the plastic rod within the plastic welder. A user-operated handle rotates at least one of the one or more engagement wheels in a first direction to advance the plastic rod along the rod passage. A heated barrel heats the plastic rod to above a melting point of the plastic rod. The heated barrel has a nozzle. The drive mechanism advances the plastic rod such that molten plastic is extruded from the nozzle.

### TECHNICAL FIELD

This relates to a plastic welder, and in particular, a feed mechanism for a plastic welder.

### BACKGROUND

Plastic welders are used to connect or reinforce plastic components. This typically involves feeding a plastic rod or string into a melt chamber and forcing the molten plastic out a nozzle to be applied to the plastic components.

### SUMMARY

According to an aspect, there is provided a plastic welder that comprises a rod passage that extends between a rod insert that receives a plastic rod and a heated barrel. One or more engagement wheels frictionally engage the plastic rod. A user-operated handle rotates at least one of the one or more engagement wheels in a first direction to advance the plastic rod along the rod passage. The heated barrel that heats the plastic rod to above a melting point of the plastic rod, the heated barrel having a nozzle, the drive mechanism advancing the plastic rod such that molten plastic is extruded from the nozzle.

According to other aspects, the plastic welder may comprise one or more of the following features, alone or in combination: the drive mechanism may comprise first and second engagement wheels on opposite sides of the rod passage; the first engagement wheel may be driven by the user-operated handle and the second engagement wheel is non-driven; the rod passage may be a hollow tube comprising access apertures that receive the first and second engagement wheels to engage the plastic rod; the rod may have a non-circular cross-section; the drive mechanism may comprise an engagement profile that is complementary to the non-circular cross-section of the rod; the rod may have has a cross-shaped cross-section; the heated barrel may have a circular inner diameter; the heated barrel may comprise an inner surface that is larger than an outer circumference of the plastic rod; the plastic welder may further comprise a heat insulator adjacent to the one or more engagement wheels and a connector tube disposed between the heat insulator and the heated barrel, the plastic rod passing through the heat insulator and the connector tube prior to entering the heated barrel; the connector tube may be stainless steel; the heated barrel and connector tube may be configured to transition the plastic rod from a solid state to a molten state in the connector tube.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of a plastic welder from a first side.

FIG. 2 is a side elevation view in section of a plastic welder from a second side.

FIG. 3 is a side elevation view in section showing an alternative sectional view of the plastic welder from the first side.

FIG. 4 is a side elevation view of the plastic welder.

FIG. 5 is a side elevation view of the plastic welder.

FIG. 6 is a perspective view in section of a plastic welder.

FIG. 7 is a detailed sectional view of the drive mechanism.

FIG. 8 is a detailed end view of a welding rod engaged by drive rollers.

FIG. 9 is a detailed end view of an alternate welding rod engaged by alternate drive rollers.

FIG. 9 is a detailed, exploded view of a removable welding tip.

### DETAILED DESCRIPTION OF PREFERRED EMBODIMENTS

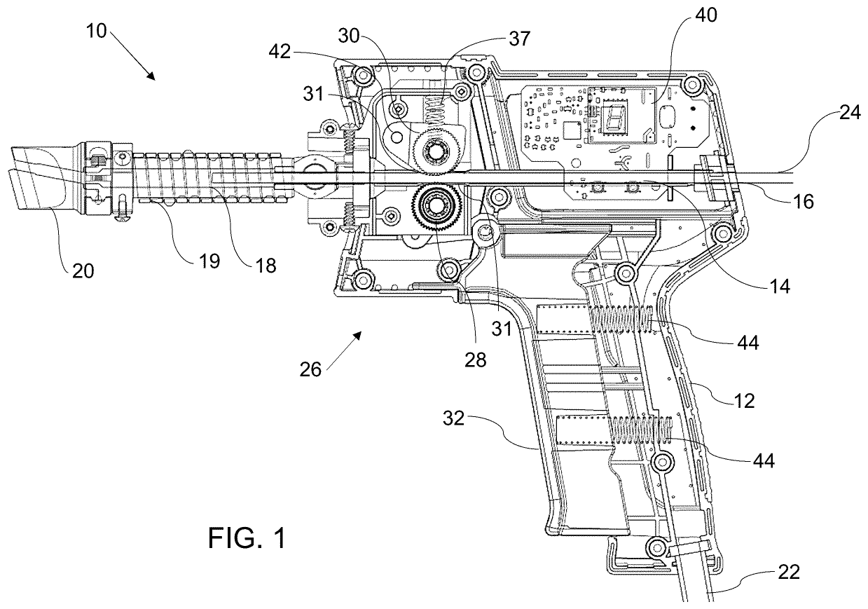

A plastic welder, generally identified by reference numeral 10, will now be described with reference to FIG. 1 through 9.

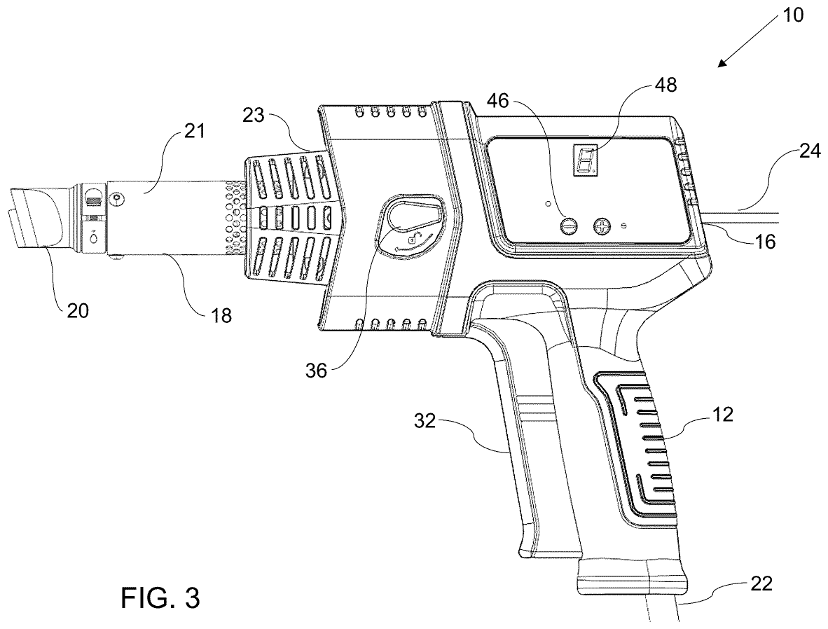

Referring to FIG. 1, plastic welder 10 has a housing 12 that houses a rod passage 14 that extends from a rod insert end 16 to a heated barrel 18. Rod insert end 16 receives plastic rods 24 that are then moved via a drive mechanism 26 through housing 12 toward heated barrel 18, where the plastic is heated to its melting point and then ejected as molten plastic from a nozzle 20. Nozzle 20 may have a fillet tip as shown, a conical tip, or other nozzle suitable for a particular type of weld being performed or the preferences of the user. Referring to FIG. 9, nozzle 20 may be replaceable, such as by removing a removable collar 52 from the end 54 of heated barrel 18. Plastic welder 10 may be electrically powered, such as by a power cord 22. Referring to FIG. 3, there may a display 48 or other indicator lights that indicate the status of welder 10, such as the temperature, preheat condition, etc. There may be other buttons 46, such as a power button that turns welder 10 on and off, temperature control buttons, or the like.

Referring to FIG. 1, heated barrel 18 has a resistive heater coil 19 that, when activated, applies sufficient heat to melt plastic rod 24. Referring to FIG. 3, heated barrel 18 and resistive heater coil 19 may be surrounded by a barrel sleeve 21 and protected by a heat guard 23. As can be seen, the passage through heated barrel 18 may narrow as it approaches the end of nozzle 20 and further narrow toward the outlet of nozzle 20. The design of heated barrel 18 and nozzle 20, inducing material and dimensions, may be selected based on the type of welding to be performed.

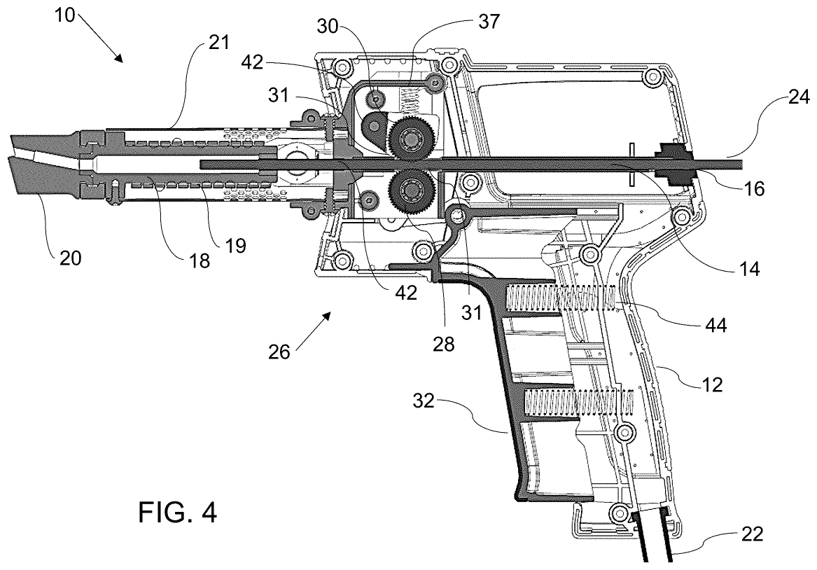

Referring to FIG. 4, plastic rod 24 is inserted into rod passage 14 and is engaged by drive mechanism 26, which advances plastic rod 24 along rod passage 14. As shown, drive mechanism 26 includes drive wheels 28 and 30 on opposed sides (i.e., top and bottom as shown) of plastic rod 24. Drive wheels 28 and 30 are positioned in apertures 31 in rod passage 14 that provides access to plastic rod 24 so that drive wheels 28 and 30 are able to engage and advance plastic rod 24 into heated barrel 18 and eject molten plastic from nozzle 20. Drive wheels 28 and 30 may be biased to apply a sufficient degree of pressure against plastic rod 24. This may be done by way of a spring 37 against one or both wheels 28 and 30.

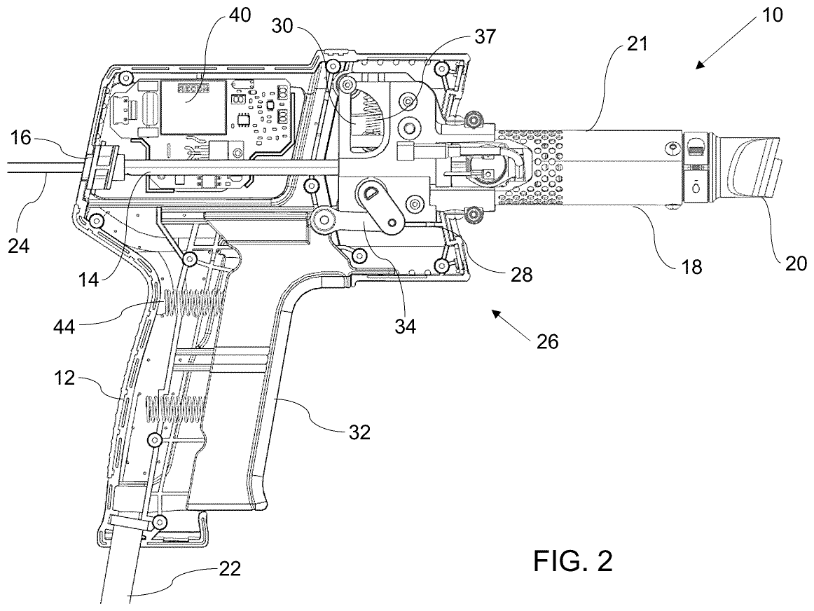

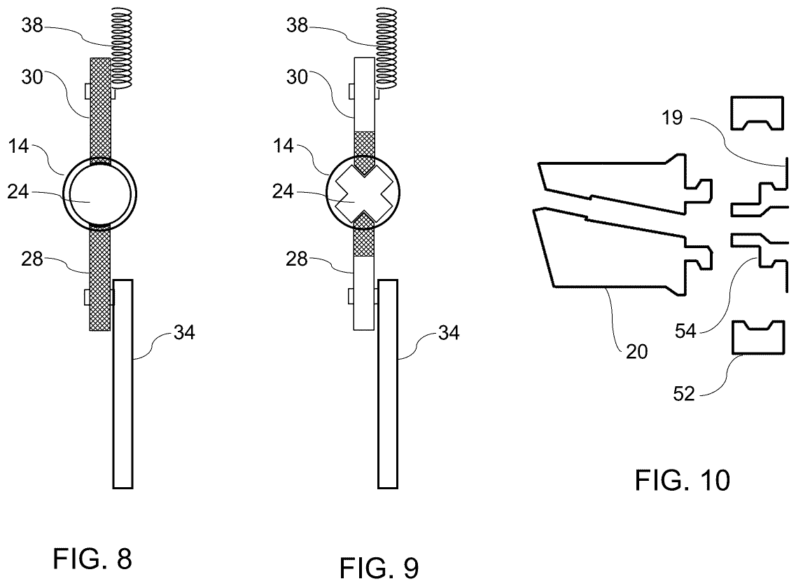

Referring to FIGS. 1 and 2, drive wheel 28 is controlled by a hand-operated lever 32 that is connected to drive wheel 28 by a control linkage 34. As lever 32 is actuated from the retracted position shown in FIG. 2 to the extended position (not shown), drive wheel 28 is rotated such that it advances plastic rod 24 as discussed above. Drive wheels 28 and 30 may be designed to be freewheeling so that they only rotate in a single direction to prevent a reverse force being applied to plastic rod 24 as lever 32 returns to the retracted position. Other types of clutch mechanisms may be provided that allows lever 32 to be returned to the retracted position without applying a reverse force on plastic rod 24. One or both of drive wheels 28 and 30 may be knurled or be provided with other surface contours or friction surfaces to better engage plastic rod 24. The shape of the drive surface of drive wheels 28 and 30 may be shaped to complement the cross-sectional shape of plastic rod 24. Referring to FIGS. 8 and 9, two examples are shown based on a round cross-section in FIG. 8 and a cross-shaped cross-section in FIG. 9. In each example, the engagement surface of drive wheels 28 and 30 are shaped to match the outer surface of plastic rod 24 t increase the engagement between drive wheels 28 and 30 and plastic rod 24. Other cross-sectional shapes and surface profiles may also be used. In addition, other designs for drive mechanism 26 are possible. For example, lever 32 may pivot rather than slide, with biasing springs 44 returning lever 32 to the original position. In other examples, a servomotor may be provided to advance one or both of drive wheels 28 and 30, a hand crank may be provided instead of lever 32, lever 32 may be positioned in a different location, etc.

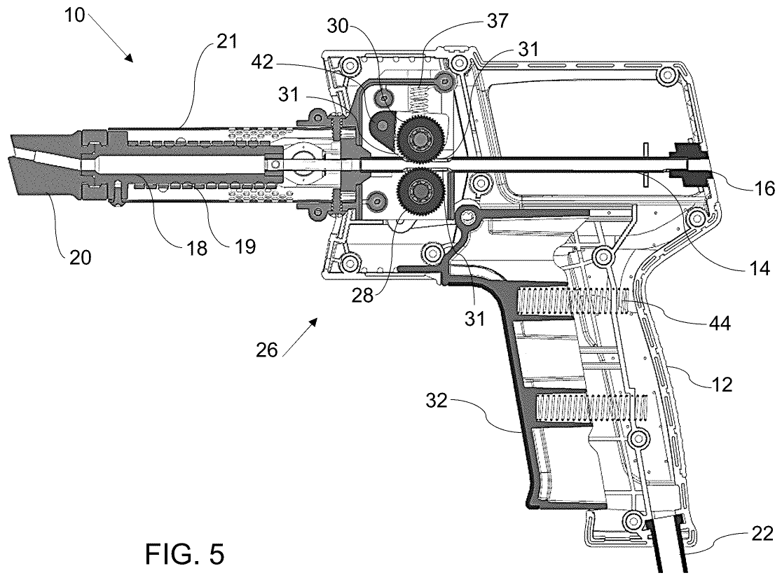

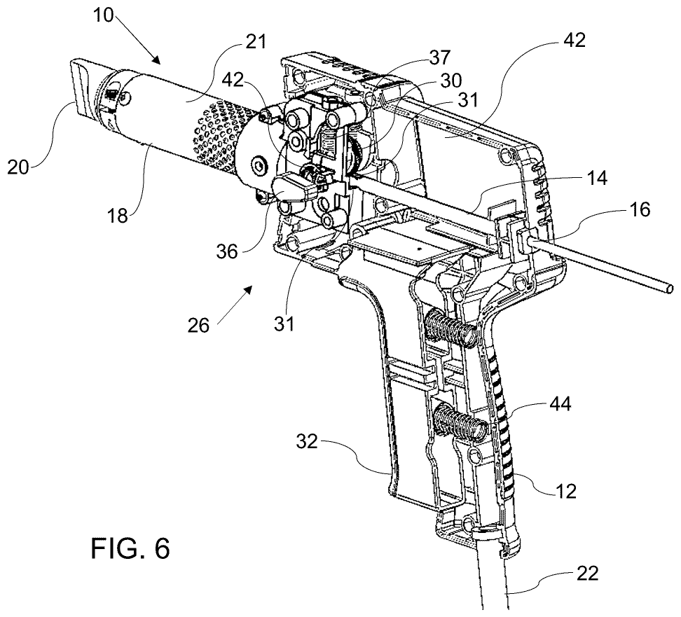

Referring to FIGS. 3 and 6, a release mechanism 36, such as a knob may be provided that lifts drive wheel 30 against the biasing force of spring 38 and allow plastic rod 24 to be disengaged and withdrawn from rod passage 14. Release mechanism 36 may be a lever that has a lock position and a release position, where actuating lever 36 may lift drive wheel 30 to allow plastic rod to be withdrawn, as shown in FIG. 5.

Referring to FIG. 9, plastic rod 24 enters heated barrel 18 and is heated to its melting point to convert plastic rod 24 to molten plastic 25, which is then extruded out nozzle 20, sometimes referred to as a shoe or tip. Plastic rod 24 reached its melting point at a certain point or within a certain range along heated barrel 18. The temperature of heated barrel 18 may be controlled, such as by using a temperature controller, found in electronics 40, which may be housed within housing 12. As the melting temperature varies between plastics, examples of which may include polyethylene, polyproylene, plastic welder 10 may include a temperature selector (not shown) that allows a user to adjust the temperature of heated barrel 18. Temperature controller 40 may also act as a safety switch to turn off heated barrel 18, such as if heated barrel 18 becomes too hot, or if the temperature at another point in plastic welder 10 becomes too hot, indicative of an overheated condition. The power may be interrupted using a high-temperature cut-off fuse (not shown). Temperature controller 40 may be connected to strategically placed thermocouples that detect the temperature at critical locations within welder 10, such as near drive wheels 28 and 30, in barrel 18, etc.

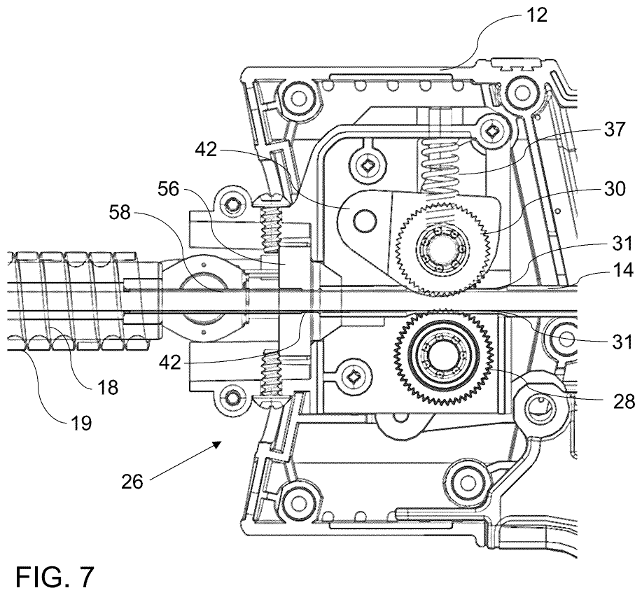

Heated barrel 18 may be designed to closely receive plastic rod 24, or it may have an inner surface with a larger cross-section than the outer perimeter of plastic rod 24. For example, heated barrel 18 may have a round cross-section, while plastic rod 24 may have a non-round cross-section, such as a round cross-section as shown in FIG. 8, or a cross-shaped cross-section as shown in FIG. 9. It has been found that, despite not fitting closely within heated barrel 18, the conversion of plastic rod 24 to a molten state occurs downstream of drive mechanism 26 such that molten plastic is still able to be extruded from nozzle 20. Referring to FIG. 7, heated barrel 18 is separated from rod passage 14 by a heat shield 56 and connector passage 58 that feeds into heated barrel 18. As shown, a gap 60 may be defined between connector passage 58 and rod passage 14 by heat shield 56. By appropriate selection of materials and dimensions for heat shield 56 and connector passage 58, the heat from heated barrel 18 is insulated from drive mechanism 26 sufficiently to ensure plastic rod 24 is solid when it is engaged by drive wheels 28 and 30, and molten before it is ejected from nozzle 20. In one example, welder 10 is designed such that plastic rod 24 becomes molten within connector passage 58. In other words, welder 10 may be designed such that plastic rod 24 enters connector passage 58 in a solid state, and exits connector passage 58 in a molten state. Solid plastic rod 24 acts as a piston to push molten plastic into barrel 18, and fills heated barrel 18 with molten plastic prior to being ejected from nozzle 20. The point along the feed path between rod insert end 16 and nozzle 20 at which plastic rod 24 melts may change during use, depending on whether the manual actuator 32 used to drive plastic rod 24 is actuated continuously or intermittently. However,

[symbol]

While other suitable materials may be used that have appropriate heat resistance, low thermal conductivity, and structural strength, in one example, the distance between heated barrel 18 and heat shield 56 is about 0.95″, heat shield 56 is made from Teflon™, and connector passage 58 is a tube of stainless steel. It was found that these materials and dimensions as sufficient for a barrel temperature of up to 320° C. with these dimensions and materials. The melt temperature will depend on the material selected for plastic rod 24, and may be as low as about 180° C. It was found that stainless steel was a suitable material for connector passage 58 as it is able to withstand the heat from heated barrel 56, while still having a relatively low thermal conductivity to prevent transferring heat to drive mechanism 26. A smaller wall thickness was found to minimize heat transfer to drive mechanism 26. In one example, connector passage may have an inner diameter of about 0.183″, an outer diameter of about 0.203″, and a wall thickness of about 0.010″. It was found that Teflon™ was a suitable material for heat insulator as it was able to sufficiently insulate against the transfer of heat, is able to withstand the heat being applied, and is sufficiently structural to support connector tube 58. The melt chamber of heated barrel 18 may be 2.8″ long with an inner diameter of 0.302″. To assist in reducing the transfer of heat from heated barrel 18 to drive mechanism 26, heat guard 23 may be perforated, along with the end of barrel sleeve 21 closest to drive mechanism 26. This allows the circulation of cooling air adjacent to connector passage 58.

During use, referring to FIGS. 1 and 2, plastic rod 24 (shown in FIGS. 8 and 6) is inserted into rod insert end 16, and advanced sufficiently along rod passage 14 to engage drive wheels 28 and 30. With heated barrel 18 at an operating temperature, lever 32 is actuated to cause drive wheels 28 and 30 to advance the plastic rod into and along heated barrel 18 toward nozzle 20. Once the plastic is molten, actuating drive wheels 28 and 30 causes molten plastic to be extruded from nozzle 20. Releasing lever 32 relaxes the pressure applied to plastic rod 24 to cease the extrusion.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A plastic welder, comprising:
a rod passage that extends between a rod insert that receives a plastic rod and a heated barrel;
a drive mechanism comprising:
one or more engagement wheels that frictionally engage the plastic rod;
a user-operated handle that rotates at least one of the one or more engagement wheels in a first direction to advance the plastic rod along the rod passage; and
a heated barrel that heats the plastic rod to above a melting point of the plastic rod, the heated barrel having a nozzle, the drive mechanism advancing the plastic rod such that molten plastic is extruded from the nozzle.

2. The plastic welder of claim 1, wherein the drive mechanism comprises first and second engagement wheels on opposite sides of the rod passage.

3. The plastic welder of claim 2, wherein the first engagement wheel is driven by the user-operated handle and the second engagement wheel is non-driven.

4. The plastic welder of claim 2, wherein the rod passage is a hollow tube comprising access apertures that receive the first and second engagement wheels to engage the plastic rod.

5. The plastic welder of claim 1, further comprising:
a heat insulator adjacent to the one or more engagement wheels; and
a connector tube disposed between the heat insulator and the heated barrel, the plastic rod passing through the heat insulator and the connector tube prior to entering the heated barrel.

6. The plastic welder of claim 5, wherein the connector tube is stainless steel.

7. The plastic welder of claim 5, wherein the heated barrel and connector tube are configured to transition the plastic rod from a solid state to a molten state in the connector tube.

8. The plastic welder of claim 1, wherein the rod passage has a non-circular cross-section.

9. The plastic welder of claim 8, wherein the one or more engagement wheels comprise an engagement profile that is complementary to the non-circular cross-section of the rod.

10. The plastic welder of claim 9, wherein the rod has a cross-shaped cross-section.

11. The plastic welder of claim 1, wherein the heated barrel has a circular inner diameter.

12. The plastic welder of claim 1, wherein the heated barrel comprises an inner surface that is larger than an outer circumference of the plastic rod.
